(19) United States
(12) Patent Application Publication
(10) Pub. No.: US 2011/0146862 A1
(43) Pub. Date: Jun. 23, 2011

(54) LOW NOISE TIRE

(75) Inventor: MARK ALLAN LAMONTIA, Landenberg, PA (US)

(73) Assignee: E. I. DU PONT DE NEMOURS AND COMPANY, Wilmington (DE)

(21) Appl. No.: 12/962,913

(22) Filed: Dec. 8, 2010

Related U.S. Application Data
(60) Provisional application No. 61/287,808, filed on Dec. 18, 2009.

(51) Int. Cl. B60C 11/03

(52) U.S. Cl. 152/209.18

(57) ABSTRACT

This invention is a tire having a first shoulder tread and a second shoulder tread and at least one intermediate tread positioned between the first shoulder tread and the second shoulder tread such that the treads extend around the circumference of the tire and form grooves that extend around the circumference of the tire, the treads comprising reinforcing fibers aligned substantially parallel to each other and oriented in a manner to decrease tire tread noise.

### BACKGROUND OF THE INVENTION

1. Field of the Invention

This invention is directed to structure and compositions that reduce tire noise.

2. Description of the Related Art

There is a continuing need for improved performance of passenger car and truck tires. Key performance attributes include noise, handling, wear, rolling resistance, and ride comfort. However, reducing tire noise is becoming an industry focus as tire companies strive to reduce noise radiated from automobile and truck tires. In 2012, the European Union is implementing legislation to reduce pass-by noise from tires by 4-6 dB.

Certain fibers have been utilized in the production of high performance tires. Published U.S. Patent Application No. 2002/0069948 teaches the use of short fibers at angles that are largely perpendicular to the tire surface. The purpose of these constructions is said to improve handling and/or acceleration. Published U.S. Patent Application No. 2007/0221303 utilizes short fibers in a construction that enhances the tread directional stiffness. These fibers are said to be aligned somewhat perpendicular to the longitudinal, circumferential direction of the tread. U.S. Pat. No. 4,871,004 discloses aramid-reinforced elastomers where short, discontinuous, fibrillated aramid fibers are dispersed in rubber, which are said to maximize lateral stiffness and modulus.

However, none of the references above are indicated as beneficial for noise reduction. U.S. Provisional Application 61/161,873, (now US Patent Publication 2010/0233669) assigned to E.I. du Pont de Nemours and Company is directed to anisotropic reinforcement to rubber tread blocks to control unwanted air pumping and resonance in the pipes formed by the tread blocks, the subtread, and the road surface, but it has been found that directing efforts to the overall tire structure can provide further benefit with respect to noise reduction.

### BRIEF DESCRIPTION OF THE DRAWINGS

FIGS. 1A-1C are schematic representations of a tire.

FIG. 2 is a schematic representation of a pipe formed by the groove that is bounded by two tire treads, the subtread, and road surface.

FIG. 3 shows a graphical depiction of noise generation in tires with grooves extending in various directions.

### DETAILED DESCRIPTION OF THE INVENTION

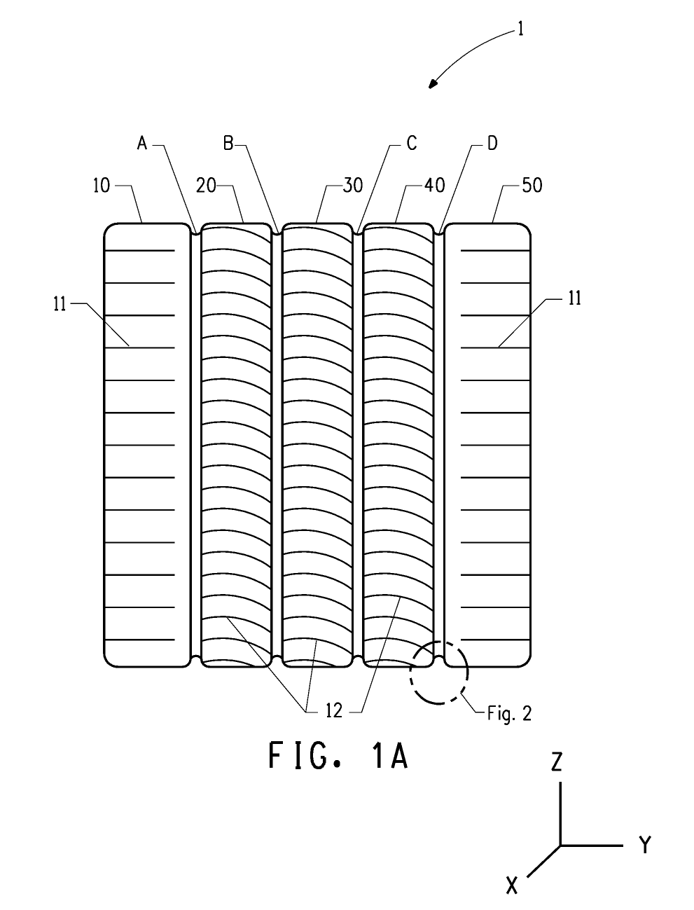

FIG. 1A shows a tire surface with two outside areas of shoulder tread 10 and shoulder tread 50 and three relatively narrower inner areas of tread, 20-40, all of which extend around the tire's circumference. Shoulder treads 10 and 50 have an outer portion adjacent to the edges of the tire. Further, shoulder treads 10 and 50 have an inner portion adjacent to groove A and groove D, respectively. The tread area boundaries create grooves, A-D. FIG. 1A further indicates the orientations with respect to the tire that will be referred to in this specification. The circumferential direction is in the direction of travel of the tire and is indicated by the X axis. The axial direction is the direction across the tread and is indicated by the Y axis. The radial direction is the direction into the tread perpendicular to the road surface and is indicated by the Z axis. As a point of clarifying the spatial relationships, the road surface is in the XY plane.

Several physical mechanisms contribute to unwanted noise generation in a tire. One of these is called air pumping. Air pumping occurs when a tread area expands laterally or circumferentially during contact with the road surface, thereby moving the surrounding air. The air pumping can result from 1) the space between neighboring treads as the constrained space is squeezed by tread deformation, or 2) the lateral or circumferential motion of a single tread. The more significant of the two routes is to pump the air from the volume between two adjoining treads as they expand toward each other upon contact with the road surface. Air can be pumped out in either the circumferential or axial directions.

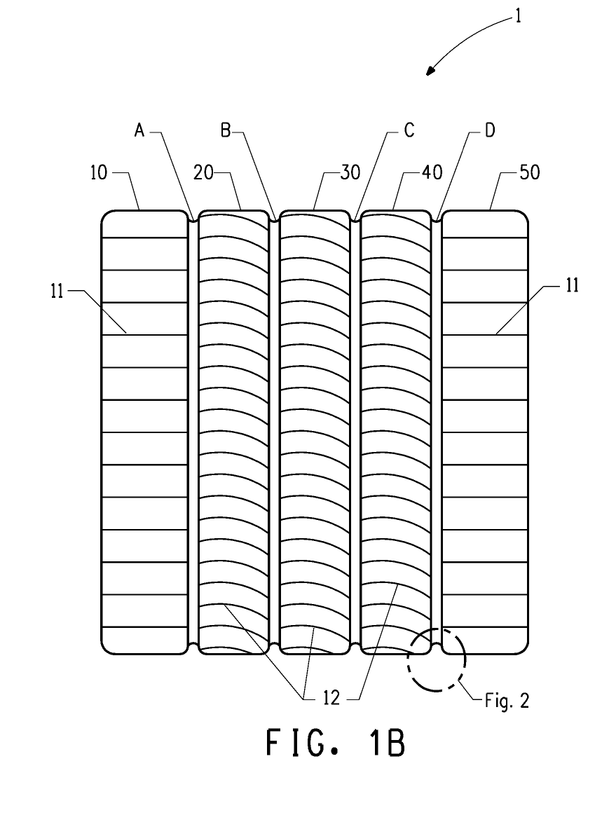

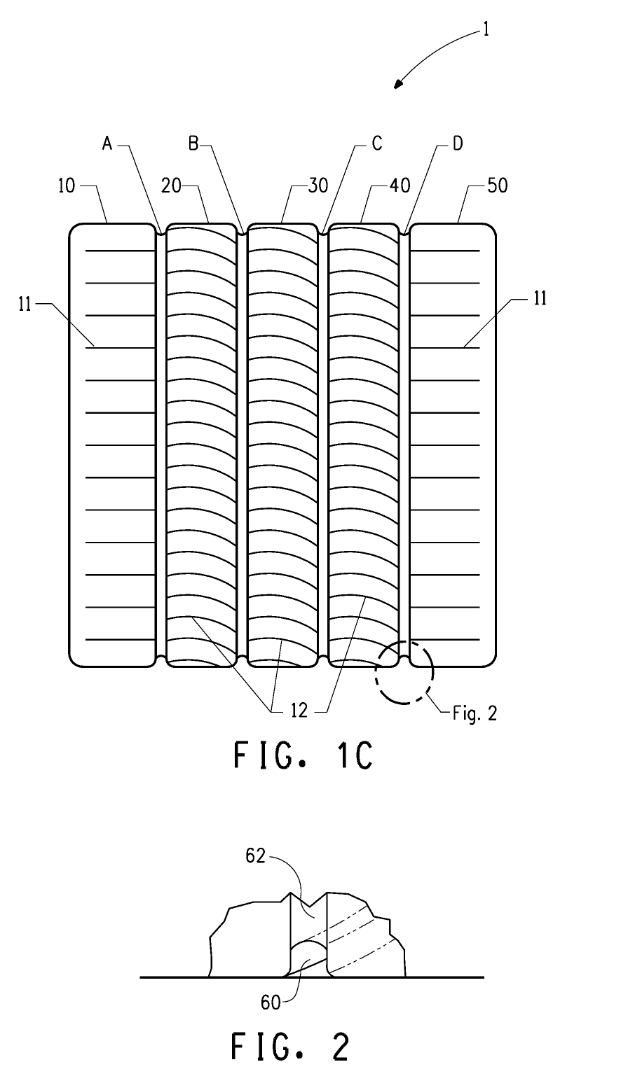

The air pumping can be further exacerbated by three effects, 1) pipe resonance, 2) Helmholtz resonance, and 3) the horn effect. A pipe can be formed two ways. The first is a pipe between tread areas and the road as depicted schematically in FIG. 2. In that case the pipe 60 is formed on the sides by the tread areas, on the top by the subtread 62 and by the road surface on the bottom. The second way as depicted, for example, in FIG. 1C is with the sipes 11, which are small grooves cut at some depth into the shoulder tread areas 10 and 50. In that case the pipe walls are formed on the sides by the sipe walls, on the top by the depth the sipe is cut into the tread area and on the bottom by the road surface. Each pipe has a natural resonant frequency, just as do the pipes in a pipe organ or other wind-driven musical instrument. When the pipe resonance coincides with the excitation frequency of the tread areas, noise amplification occurs.

Helmholtz resonance occurs in the region of the tread and road interface. Helmholtz resonance is generated by an increase followed by a relief of pressure in the air cavity formed by neighboring treads. As the cavity reduces in volume just before its neighboring tread reaches the tire contact patch, the pressure in the entrapped volume rises. Helmholtz noise is generated when this elevated pressure air is expelled through the small slit just before the tread closes off the cavity. Helmholtz noise can be generated in both the circumferential and axial directions.

The horn effect occurs when the road surface and the tire combine to form the shape of a horn. This most dramatically occurs at the front of the tire and at the back of the tire. In both cases, the top of the horn is defined by the circumference of the tire, and the bottom of the horn is defined by the road surface. This also occurs to a lesser degree at the side of the tire where the top of the horn is defined by the tire carcass near the road and the bottom of the horn is defined by the road surface.

The tread in the center treads 20-40 contain fibers oriented in the axial direction to control air pumping and pipe resonance in grooves A, B, C, and D and thus decrease circumferential noise (both to the front and to the rear). In addition to achieving lower air pumping, tread radial compliance is preserved by avoiding radial reinforcement.

The reinforcement in shoulder treads 10 and 50 can be present in two different arrangements, depending on the location of sipes 11. The first arrangement is used when, as shown in FIG. 1A, the outer portion of either of shoulder treads 10 or 50 contain sipes that start at the outside of the tread but do not extend into grooves A or D, respectively. In this instance, the fibers are in the axial direction in the areas neighboring the grooves A and D where sipes are absent, but the fibers are in the circumferential direction and substantially perpendicular to the sipes located at the outer portion of the tread. The axial reinforcement further reduces air pumping in grooves A and D. The circumferential reinforcement surrounding the sipes reduces air pumping in the sipes and between neighboring treads in the circumferential direction.

The second arrangement is used when, as shown in FIG. 1B, the treads contain sipes that extend from the outside of the tread into grooves A or D or when, as shown in FIG. 1C, the sipes start within the tread and extend into grooves A or D. In this instance, reinforced shoulder tread areas 10 and 50 have fibers in the circumferential direction substantially perpendicular to the sipes. The circumferential direction reinforcement surrounding the sipes reduces air pumping in the sipes and also between neighboring treads in the circumferential direction.

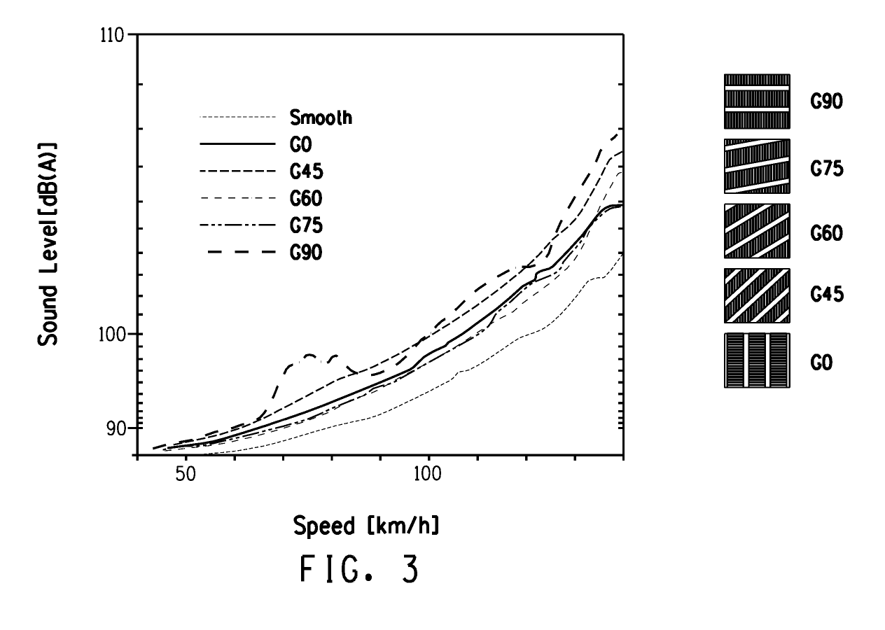

It should be recognized that a vehicle tire in normal use typically has a tread pattern that is quite complex in that it is composed of a plurality of grooves and sipes having different lengths, depths, and orientations. As such, there are likewise many areas in the tread where the subject unidirectional short fibers can be positioned to achieve reinforcement of the tread resulting in the desired decrease in tire noise. For example, FIG. 3 graphically depicts the noise generated as a function of speed utilizing a simplifed representation of tires with grooves that range from totally circumferential (0° with respect to the circumferential direction) to totally axial, also called lateral (90° with respect to the circumferential) direction, which are designated G0 and G90, respectively. FIG. 3 also includes data from tires with grooves that are angled at 45°, 60°, and 75° with respect to the circumferential direction, which are designated G45, G60 and G75, respectively. Data from a smooth tire is presented as the lowest noise base line, recognizing that such a tire would have no pipes to exhibit pipe resonance, but would also not be acceptable for normal street driving. For G90, the reinforcing fibers would be added to the tread in a circumferential orientation to limit movement of the groove wall in the circumferential direction. For G0, the reinforcing fibers would be added to the tread in an axial orientation to limit movement of the groove wall in the axial direction. For those tires having grooves at an angular orientation (G45, G60 and G75), the reinforcing fibers would be added to the tread in an orientation substantially perpendicular to the baseline of the particular angle of the groove. Similarly, reinforcing fibers can be added to tires with sipes in the axial direction, the cirumferential direction, or sipes with an angular orientation, and the reinforcing fibers would be added to the tread in an orientation substantially perpendicular to the baseline of the particular angle of the sipe. Essentially, the reinforcing fibers are preferably added perpendicularly to the length dimension of the groove or the sipe. As noted above, grooves can vary considerably in their overall length, in their width or in their depth, but all can form a pipe that will generate noise to some extent. However, it would be expensive and time consuming to provide a specific orientation for each such groove segment. Regardless, significant decrease in noise can be achieved by appropriate placement of the unidirectional fibers in the locations in the tire where the most noise is generated.

It is further noted that the fibers can be added as reinforcement to the subtread in the radial direction across the crown of the tire, which is represented by the top 62 of the pipe 60 as depicted in FIG. 2.

Importantly, the decrease in noise generation in the various embodiments of this invention can be achieved without significant loss in other performance parameters. In fact, the tire is expected to exhibit decreased rolling resistance due to lowering rubber deformation where the reinforcement exists, and to exhibit increased durability due to lowering internal heat build-up in the tire in the area where the reinforcement exists.

As noted above, this invention is directed to the overall tire design. Noise reduction in tires can be accomplished by incorporating certain types of short fibers or pulp into the tread areas and placing the tread areas strategically to lower noise coming from the tire in the circumferential (both front and rear) direction, and the axial direction. That is, by incorporating these short fibers or pulp into the tread, anisotropic reinforcement of the tread is achieved. The fibers are arranged in the tread such that they are substantially parallel to each other in whatever orientation is desired. By substantially, we mean that over 50% of the short fibers are oriented in one direction. More preferably, greater than 70% of the short fibers are oriented in one direction. Most preferably, greater than 85% of the short fibers are oriented in one direction. By aligned or oriented, it is meant that the fiber is arranged such that the long dimension of the fiber is oriented in the aligned direction. In some embodiments, the higher the modulus of the short fiber or pulp, the better is the obtained performance. Thus, high modulus fibers such as aramid fibers and pulp can be advantageously placed in the tread. It should be noted, however, that in addition to aramids, any short fibers or pulp that increase the tread stiffness in the desired orientation would be suitable.

Such fibers may be used directly during the compounding of the fiber or may be added as a premix or masterbatch in which the fiber is pre-blended into a concentrate with some of the elastomer. The tread of this invention comprise cured elastomer having from 0.1 to 10 parts per hundred parts by weight of the elastomer of short fibers. The fibers have a tenacity of at least 6 grams per dtex and a modulus of at least 200 grams per dtex. The short fibers may be cut from continuous fibers to form floc, pulp, and other chopped fiber forms.

Some fibers have a ratio of length to diameter of 5 to 10,000 more preferably 10 to 5000. Short fibers having a diameter of less than 15 micrometers, as discussed herein relating to this invention, include pulp and fibers known as floc. Floc is made by cutting continuous fiber into short lengths from about 0.1 to 8 millimeters, more preferably from about 0.1 to 6 millimeters. Manufacture of such fibers is well known to those skilled in the art. Certain of these fibers, including those coated with an adhesion promoting agent, are available commercially.

Some fibers used in the present invention are in the form of pulp. Pulp comprises fibrillated fibers that in some cases are produced by chopping longer fibers. Aramid pulp, for example, can be made by refining aramid fibers and, in some embodiments, has a distribution of lengths up to about 8 millimeters with an average length of about 0.1 to 4 millimeters. Commercially available aramid pulps include Kevlar® pulp, from DuPont and Teijin™ Twaron® pulp. Another form of pulp, known as micropulp, can be produced in accordance with US Patent Publication number 2003/0114641. This pulp has a volume average length ranging from 0.01 micrometers to 100 micrometers and an average surface area ranging from 25 to 500 square meter per gram. As used herein, the volume average length means:

Σ(number of fibers of given length)×(length of each fiber)⁴/Σ(number of fibers of given length)×(length of each fiber)³

Unless noted otherwise, fibers discussed herein include traditional short fibers and pulp within their definition.

### Fiber Polymer

The fibers and pulp used herein can be made from any polymer that produces a high-strength fiber, including, for example, aromatic or aliphatic polyamides, aromatic or aliphatic polyesters, polyacrylonitrile, polyolefins, cellulose, polyazoles and mixtures of these.

When the polymer is polyamide, in some embodiments, aramid is preferred. The term “aramid” means a polyamide wherein at least 85% of the amide (—CONH—) linkages are attached directly to two aromatic rings. Suitable aramid fibers include Twaron®, Sulfron®, Technora® all available from Teijin Aramid, Heracon™ from Kolon Industries Inc. or Kevlar® available from Dupont. Aramid fibers are described in Man-Made Fibres—Science and Technology, Volume 2, Section titled Fibre-Forming Aromatic Polyamides, page 297, W. Black et al., Interscience Publishers, 1968. Aramid fibers and their production are, also, disclosed in U.S. Pat. Nos. 3,767,756; 4,172,938; 3,869,429; 3,869,430; 3,819,587; 3,673,143; 3,354,127; and 3,094,511.

In some embodiments, the preferred aramid is a para-aramid. One preferred para-aramid is poly(p-phenylene terephthalamide) which is called PPD-T. By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

When the polymer is polyolefin, in some embodiments, polyethylene or polypropylene is preferred. Polyolefin fibers can only be used when the processing temperatures required to compound the fiber and elastomer, to calendar or extrude the compound or to cure the compound in the tire assembly is less than the melting point of the polyolefin. The term “polyethylene” means a predominantly linear polyethylene material of preferably more than one million molecular weight that may contain minor amounts of chain branching or comonomers not exceeding 5 modifying units per 100 main chain carbon atoms, and that may also contain admixed therewith not more than about 50 weight percent of one or more polymeric additives such as alkene-1-polymers, in particular low density polyethylene, propylene, and the like, or low molecular weight additives such as anti-oxidants, lubricants, ultra-violet screening agents, colorants and the like which are commonly incorporated. Such is commonly known as extended chain polyethylene (ECPE) or ultra high molecular weight polyethylene (UHMWPE). Preparation of polyethylene fibers is discussed in U.S. Pat. Nos. 4,478,083, 4,228,118, 4,276,348 and 4,344,908. High molecular weight linear polyolefin fibers are commercially available. Preparation of polyolefin fibers is discussed in U.S. Pat. No. 4,457,985.

In some preferred embodiments polyazoles are polyarenazoles such as polybenzazoles and polypyridazoles. Suitable polyazoles include homopolymers and, also, copolymers. Additives can be used with the polyazoles and up to as much as 10 percent, by weight, of other polymeric material can be blended with the polyazoles. Also copolymers can be used having as much as 10 percent or more of other monomer substituted for a monomer of the polyazoles. Suitable polyazole homopolymers and copolymers can be made by known procedures, such as those described in or derived from U.S. Pat. Nos. 4,533,693, 4,703,103, 5,089,591, 4,772,678, 4,847,350, and 5,276,128.

Preferred polybenzazoles include polybenzimidazoles, polybenzothiazoles, and polybenzoxazoles and more preferably such polymers that can form fibers having yarn tenacities of 30 grams per denier (gpd) or greater. In some embodiments, if the polybenzazole is a polybenzothioazole, preferably it is poly(p-phenylene benzobisthiazole). In some embodiments, if the polybenzazole is a polybenzoxazole, preferably it is poly(p-phenylene benzobisoxazole) and more preferably the poly(p-phenylene-2,6-benzobisoxazole) called PBO.

Preferred polypyridazoles include polypyridimidazoles, polypyridothiazoles, and polypyridoxazoles and more preferably such polymers that can form fibers having yarn tenacities of 30 gpd or greater. In some embodiments, the preferred polypyridazole is a polypyridobisazole. One preferred poly(pyridobisozazole) is poly(1,4-(2,5-dihydroxy)phenylene-2,6-pyrido[2,3-d:5,6-d′]bisimidazole which is called PIPD. Suitable polypyridazoles, including polypyridobisazoles, can be made by known procedures, such as those described in U.S. Pat. No. 5,674,969.

The term “polyester” as used herein is intended to embrace polymers wherein at least 85% of the recurring units are condensation products of dicarboxylic acids and dihydroxy alcohols with linkages created by formation of ester units. This includes aromatic, aliphatic, saturated, and unsaturated di-acids and di-alcohols. The term “polyester” as used herein also includes copolymers (such as block, graft, random and alternating copolymers), blends, and modifications thereof. In some embodiments, the preferred polyesters include poly (ethylene terephthalate), poly (ethylene naphthalate), and liquid crystalline polyesters. Poly (ethylene terephthalate) (PET) can include a variety of comonomers, including diethylene glycol, cyclohexanedimethanol, poly(ethyl ene glycol), glutaric acid, azelaic acid, sebacic acid, isophthalic acid, and the like. In addition to these comonomers, branching agents like trimesic acid, pyromellitic acid, trimethylolpropane and trimethyloloethane, and pentaerythritol may be used. The poly (ethylene terephthalate) can be obtained by known polymerization techniques from either terephthalic acid or its lower alkyl esters (e.g. dimethyl terephthalate) and ethylene glycol or blends or mixtures of these. Another potentially useful polyester is poly (ethylene napthalate) (PEN). PEN can be obtained by known polymerization techniques from 2,6 napthalene dicarboxylic acid and ethylene glycol.

Liquid crystalline polyesters may also be used in the invention. By “liquid crystalline polyester” (LCP) herein is meant polyester that is anisotropic when tested using the TOT test or any reasonable variation thereof, as described in U.S. Pat. No. 4,118,372. One preferred form of liquid crystalline polyesters is “all aromatic”; that is, all of the groups in the polymer main chain are aromatic (except for the linking groups such as ester groups), but side groups which are not aromatic may be present.

E-Glass is a commercially available low alkali glass. One typical composition consists of 54 weight % SiO₂, 14 weight % Al₂O₃, 22 weight % CaO/MgO, 10 weight % B₂O₃ and less then 2 weight % Na₂O/K₂O, Some other materials may also be present at impurity levels.

S-Glass is a commercially available magnesia-alumina-silicate glass. This composition is stiffer, stronger, more expensive than E-glass and is commonly used in polymer matrix composites.

Carbon fibers are commercially available and well known to those skilled in the art. In some embodiments, these fibers are about 0.005 to 0.010 mm in diameter and composed mainly of carbon atoms.

Cellulosic fibers can be made by spinning liquid crystalline solutions of cellulose esters (formate and acetate) with subsequent saponification to yield regenerated cellulosic fibers.

1. A tire having a first shoulder tread and a second shoulder tread and at least one intermediate tread positioned between the first shoulder tread and the second shoulder tread such that the treads extend around the circumference of the tire and form grooves that extend around the circumference of the tire, the treads comprising reinforcing fibers aligned substantially parallel to each other and oriented in a manner to decrease tire tread noise.

2. The tire according to claim 1, wherein at least one of the first shoulder tread and the second shoulder tread have an inner portion and an outer portion and comprises a plurality of sipes that are substantially axial in orientation and the reinforcing fibers are substantially perpendicular to the sipes.

3. The tire according to claim 2, wherein the sipes in at least one of the first shoulder tread and the second shoulder tread are located primarily in the outer portion and do not extend inward so as to intersect with the grooves.

4. The tire according to claim 2, wherein the sipes in at least one of the first shoulder tread and the second shoulder are located primarily in the inner portion and intersect with the grooves but do not extend into the outer portion of the first shoulder tread and the second shoulder tread.

5. The tire according to claim 2, wherein the sipes in at least one of the first shoulder tread and the second shoulder tread are located in the outer and inner portions and intersects with the grooves.

6. The tire according to claim 3, wherein the reinforcing fibers in the outer portion are oriented in the circumferential direction and are substantially perpendicular to the sipes and the reinforcing fibers in the inner portion are oriented in the axial direction.

7. The tire according to claim 4, wherein the reinforcing fibers in the inner portion are oriented in the circumferential direction and are substantially perpendicular to the sipes.

8. The tire according to claim 5, wherein the reinforcing fibers in both the outer portion and the inner portion are oriented in the circumferential direction and are substantially perpendicular to the sipes.

9. The tire according to claim 1, wherein the intermediate tread comprises a plurality of sipes that are substantially axial in orientation and the reinforcing fibers are substantially perpendicular to the sipes.

10. The tire according to claim 1, wherein the intermediate tread comprises a plurality of sipes that are substantially circumferential in orientation and the reinforcing fibers are substantially perpendicular to the sipes.

11. The tire according to claim 1, wherein the intermediate tread comprises a plurality of sipes that are positioned such that the angle of orientation is within the range between an axial orientation and a circumferential orientation and the reinforcing fibers are substantially perpendicular to the sipes.
